(19) United States
(12) Patent Application Publication
(10) Pub. No.: US 2023/0164819 A1
(43) Pub. Date: May 25, 2023

(54) UPLINK CONTROL INFORMATION MULTIPLEXING RULE FOR SIMULTANEOUS UPLINK CONTROL CHANNEL AND UPLINK SHARED CHANNEL TRANSMISSION

(71) Applicant: QUALCOMM Incorporated, San Diego, CA (US)

(72) Inventors: Fang YUAN, Beijing (CN); Wooseok NAM, San Diego, CA (US); Mostafa KHOSHNEVISAN, San Diego, CA (US); Tao LUO, San Diego, CA (US); Xiaoxia ZHANG, San Diego, CA (US); Juan MONTOJO, San Diego, CA (US)

(21) Appl. No.: 17/997,726

(22) PCT Filed: Jun. 25, 2020
(86) PCT No.: PCT/CN2020/098294

§ 371 Date: Nov. 1, 2022

(51) Int. Cl. H04W 72/51; H04W 8/24; H04W 72/21

(52) U.S. Cl. CPC H04W 72/51; H04W 8/24; H04W 72/21; H04B 7/0626

(57) ABSTRACT

Methods, systems, and devices for wireless communications are described. A user equipment (UE) may determine a capability to support a mode of uplink control information (UCI) transmission corresponding to transmitting the UCI on an uplink control channel and an uplink signal on an uplink shared channel when the resources of the uplink control channel and the resources of the uplink shared channel are at least partially overlapping. In a first UCI transmission mode, the UE may transmit UCI on an uplink control channel with resources that overlap with an uplink shared channel. In another UCI transmission mode, the UE may multiplex the UCI in the uplink shared channel. The base station may transmit a configuration indicating to the UE to use a UCI transmission mode. The UE may transmit UCI on the uplink control channel and uplink signal on the uplink shared channel based on the configuration.

### CROSS REFERENCE

The present Application is a 371 national stage filing of International PCT Application No. PCT/CN2020/098294 by YUAN et al. entitled “UPLINK CONTROL INFORMATION MULTIPLEXING RULE FOR SIMULTANEOUS UPLINK CONTROL CHANNEL AND UPLINK SHARED CHANNEL TRANSMISSION,” filed Jun. 25, 2020, which is assigned to the assignee hereof, and which is expressly incorporated by reference in its entirety herein.

### FIELD OF TECHNOLOGY

The following relates generally to wireless communications and more specifically to an uplink control information (UCI) multiplexing rule for simultaneous uplink control channel and uplink shared channel transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support an uplink control information (UCI) multiplexing rule for simultaneous uplink control channel and uplink shared channel transmission. Generally, the described techniques provide for a user equipment (UE) to determine a capability to support a mode of UCI transmission corresponding to transmitting the UCI on an uplink control channel (e.g., a physical uplink control channel (PUCCH)) and an uplink signal on an uplink shared channel (e.g., a physical uplink shared channel (PUSCH)) when the resources of the PUCCH and the resources of the PUSCH are at least partially overlapping. In some cases, the UE may be capable of performing one or more modes of UCI transmission. For example, in a first UCI transmission mode, the UE may transmit UCI on a PUCCH with resources (e.g., time-frequency resources) that overlap with a PUSCH. In another UCI transmission mode, the UE may multiplex the UCI in the PUSCH and, in some cases, may drop the PUCCH. In some cases, the UE may transmit an indication of the capability to a base station. In some examples, the base station may transmit a configuration indicating to the UE to use a UCI transmission mode. The UE may transmit UCI on the PUCCH and uplink signal on the PUSCH based on the configuration from the base station, which may improve reliability (e.g., coverage) at the UE.

A method of wireless communications at a UE is described. The method may include determining a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receiving, from a base station, a configuration indicating that the UE is to use the first mode of UCI transmission, and transmitting, based on the received configuration, the UCI on the uplink control channel and an uplink signal on the uplink shared channel.

An apparatus for wireless communications at a UE is described. The apparatus may include a processor, memory coupled with the processor, and instructions stored in the memory. The instructions may be executable by the processor to cause the apparatus to determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receive, from a base station, a configuration indicating that the UE is to use the first mode of UCI transmission, and transmit, based on the received configuration, the UCI on the uplink control channel and an uplink signal on the uplink shared channel.

Another apparatus for wireless communications at a UE is described. The apparatus may include means for determining a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receiving, from a base station, a configuration indicating that the UE is to use the first mode of UCI transmission, and transmitting, based on the received configuration, the UCI on the uplink control channel and an uplink signal on the uplink shared channel.

A non-transitory computer-readable medium storing code for wireless communications at a UE is described. The code may include instructions executable by a processor to determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receive, from a base station, a configuration indicating that the UE is to use the first mode of UCI transmission, and transmit, based on the received configuration, the UCI on the uplink control channel and an uplink signal on the uplink shared channel.

Some examples of the method, apparatuses, and non-transitory computer-readable medium described herein may further include operations, features, means, or instructions for transmitting, to the base station, an indication of the determined capability.

Some examples of the method, apparatuses, and non-transitory computer-readable medium described herein may further include operations, features, means, or instructions for determining that the uplink control channel and the uplink shared channel may be configured on a same serving cell, where the capability of the UE may be determined based on the uplink control channel and the uplink shared channel being configured on the same serving cell.

Some examples of the method, apparatuses, and non-transitory computer-readable medium described herein may further include operations, features, means, or instructions for determining that the uplink control channel may be configured on a first serving cell and the uplink shared channel may be configured on a second serving cell different than the first serving cell, where the capability of the UE may be determined based on the uplink control channel being configured on a different serving cell than the uplink shared channel.

Some examples of the method, apparatuses, and non-transitory computer-readable medium described herein may further include operations, features, means, or instructions for determining that the uplink control channel overlaps in time at least in part with the uplink shared channel during a time period, where the uplink control channel and the uplink shared channel may be configured on the same serving cell.

Some examples of the method, apparatuses, and non-transitory computer-readable medium described herein may further include operations, features, means, or instructions for dropping a scheduling request based on the uplink control channel overlapping with the uplink shared channel during the time period.

Some examples of the method, apparatuses, and non-transitory computer-readable medium described herein may further include operations, features, means, or instructions for determining an absence of a second type of channel state information (CSI) reporting during the time period, and multiplexing a first type of CSI reporting based on the absence of the second type of CSI reporting.

Some examples of the method, apparatuses, and non-transitory computer-readable medium described herein may further include operations, features, means, or instructions for determining the uplink control channel does not overlap in time with the uplink shared channel during a time period, and transmitting, to the base station, a scheduling request based on the uplink control channel not overlapping in time with the uplink shared channel during the time period.

Some examples of the method, apparatuses, and non-transitory computer-readable medium described herein may further include operations, features, means, or instructions for receiving the configuration via radio resource control (RRC) signaling.

A method of wireless communications at a base station is described. The method may include determining a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmitting, to the UE, a configuration indicating that the UE is to use the first mode of UCI transmission, and receiving, based on the transmitted configuration, the UCI on the uplink control channel and an uplink signal on the uplink shared channel.

An apparatus for wireless communications at a base station is described. The apparatus may include a processor, memory coupled with the processor, and instructions stored in the memory. The instructions may be executable by the processor to cause the apparatus to determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmit, to the UE, a configuration indicating that the UE is to use the first mode of UCI transmission, and receive, based on the transmitted configuration, the UCI on the uplink control channel and an uplink signal on the uplink shared channel.

Another apparatus for wireless communications at a base station is described. The apparatus may include means for determining a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmitting, to the UE, a configuration indicating that the UE is to use the first mode of UCI transmission, and receiving, based on the transmitted configuration, the UCI on the uplink control channel and an uplink signal on the uplink shared channel.

A non-transitory computer-readable medium storing code for wireless communications at a base station is described. The code may include instructions executable by a processor to determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmit, to the UE, a configuration indicating that the UE is to use the first mode of UCI transmission, and receive, based on the transmitted configuration, the UCI on the uplink control channel and an uplink signal on the uplink shared channel.

Some examples of the method, apparatuses, and non-transitory computer-readable medium described herein may further include operations, features, means, or instructions for receiving, from the UE, an indication of the determined capability.

In some examples of the method, apparatuses, and non-transitory computer-readable medium described herein, the configuration may be transmitted based on the uplink control channel lacking a beam configuration.

Some examples of the method, apparatuses, and non-transitory computer-readable medium described herein may further include operations, features, means, or instructions for determining that the uplink control channel and the uplink shared channel may be configured on a same serving cell, where the capability of the UE may be determined based on the uplink control channel and the uplink shared channel being configured on the same serving cell.

Some examples of the method, apparatuses, and non-transitory computer-readable medium described herein may further include operations, features, means, or instructions for determining that the uplink control channel may be configured on a first serving cell and the uplink shared channel may be configured on a second serving cell different than the first serving cell, where the capability of the UE may be determined based on the uplink control channel being configured on a different serving cell than the uplink shared channel.

Some examples of the method, apparatuses, and non-transitory computer-readable medium described herein may further include operations, features, means, or instructions for determining that the uplink control channel overlaps in time at least in part with the uplink shared channel during a time period, where the uplink control channel and the uplink shared channel may be configured on the same serving cell.

Some examples of the method, apparatuses, and non-transitory computer-readable medium described herein may further include operations, features, means, or instructions for receiving, from the UE, a multiplexed transmission including a first type of CSI reporting based on an absence of a second type of CSI reporting.

In some examples of the method, apparatuses, and non-transitory computer-readable medium described herein, the first type of CSI reporting may be periodic and the second type of CSI may be aperiodic or semi-persistent.

Some examples of the method, apparatuses, and non-transitory computer-readable medium described herein may further include operations, features, means, or instructions for receiving, from the UE, a scheduling request based on the uplink control channel not overlapping in time with the uplink shared channel during a time period.

Some examples of the method, apparatuses, and non-transitory computer-readable medium described herein may further include operations, features, means, or instructions for transmitting the configuration via RRC signaling.

### BRIEF DESCRIPTION OF THE DRAWINGS

FIGS. 1 and 2 illustrate examples of wireless communications systems that support an uplink control information (UCI) multiplexing rule for simultaneous uplink control channel and uplink shared channel transmission in accordance with aspects of the present disclosure.

FIGS. 3 and 4 illustrate examples of processing timelines that support a UCI multiplexing rule for simultaneous uplink control channel and uplink shared channel transmission in accordance with aspects of the present disclosure.

FIG. 5 illustrates an example of a process flow that supports a UCI multiplexing rule for simultaneous uplink control channel and uplink shared channel transmission in accordance with aspects of the present disclosure.

FIGS. 6 and 7 show block diagrams of devices that support a UCI multiplexing rule for simultaneous uplink control channel and uplink shared channel transmission in accordance with aspects of the present disclosure.

FIG. 8 shows a block diagram of a communications manager that supports a UCI multiplexing rule for simultaneous uplink control channel and uplink shared channel transmission in accordance with aspects of the present disclosure.

FIG. 9 shows a diagram of a system including a device that supports a UCI multiplexing rule for simultaneous uplink control channel and uplink shared channel transmission in accordance with aspects of the present disclosure.

FIGS. 10 and 11 show block diagrams of devices that support a UCI multiplexing rule for simultaneous uplink control channel and uplink shared channel transmission in accordance with aspects of the present disclosure.

FIG. 12 shows a block diagram of a communications manager that supports a UCI multiplexing rule for simultaneous uplink control channel and uplink shared channel transmission in accordance with aspects of the present disclosure.

FIG. 13 shows a diagram of a system including a device that supports a UCI multiplexing rule for simultaneous uplink control channel and uplink shared channel transmission in accordance with aspects of the present disclosure.

FIGS. 14 through 17 show flowcharts illustrating methods that support a UCI multiplexing rule for simultaneous uplink control channel and uplink shared channel transmission in accordance with aspects of the present disclosure.

### DETAILED DESCRIPTION

In some examples, a user equipment (UE) may receive one or more downlink control information (DCI) messages from a base station. For example, the UE may receive DCI associated with an uplink shared channel (e.g., a physical uplink shared channel (PUSCH)) transmission and DCI associated with a downlink shared channel (e.g., a physical downlink shared channel (PDSCH)) transmission. The UE may attempt to transmit uplink control information (UCI) (e.g., a feedback message, a scheduling request, a channel state information (CSI) report, or the like) in response to the PDSCH transmission on an uplink control channel (e.g., a physical uplink control channel (PUCCH)) and an uplink signal (e.g., including control information or data) on the PUSCH. In some cases, the UE may multiplex at least a portion of the UCI and the uplink signal on the PUSCH when resources, such as time-frequency resources, associated with the PUCCH overlap with resources associated with the PUSCH. In some other cases, the resources associated with the PUCCH may not overlap with the resources associated with the PUSCH. However, the UE may multiplex acknowledgement feedback information, CSI, or both in the PUSCH, and may drop the PUCCH, including any other UCI that would have been transmitted on the PUCCH, which may cause inefficient communication (e.g., due to retransmission of UCI).

As described herein, a UE may determine a capability to support a mode of UCI transmission corresponding to transmitting the UCI on a PUCCH and an uplink signal on a PUSCH concurrently when the resources of the PUCCH and the resources of the PUSCH are at least partially overlapping in time, which may improve reliability (e.g., coverage) at the UE. In some cases, the UE may be capable of performing one or more modes of UCI transmission. For example, in a UCI transmission mode, the UE may transmit UCI on a PUCCH with resources (e.g., time-frequency resources) that overlap with a PUSCH and may also transmit the overlapped PUSCH. In another UCI transmission mode, the UE may multiplex the UCI in the overlapped PUSCH and, in some cases, may drop the PUCCH.

In some cases, the UE may transmit an indication of the capability to a base station. In some examples, the base station may transmit a configuration indicating to the UE to use a UCI transmission mode. The UE may transmit UCI on the PUCCH and uplink signal on the PUSCH based on the configuration of the UCI transmission mode from the base station. In some cases, the base station may transmit the configuration to the UE via RRC signaling. In some examples, the UE may receive an RRC configuration from the base station if a serving cell of the PUCCH is not configured with a transmission control information (TCI) state (e.g., the PUCCH may lack a beam configuration). In some cases, the PUCCH and the PUSCH may be associated with the same serving cell. In some other cases, the PUCCH and the PUSCH may be associated with different serving cells.

Aspects of the disclosure are initially described in the context of wireless communications systems. Additional aspects of the disclosure are described with reference to processing timelines and a process flow. Aspects of the disclosure are further illustrated by and described with reference to apparatus diagrams, system diagrams, and flowcharts that relate to a UCI multiplexing rule for simultaneous uplink control channel and uplink shared channel transmission.

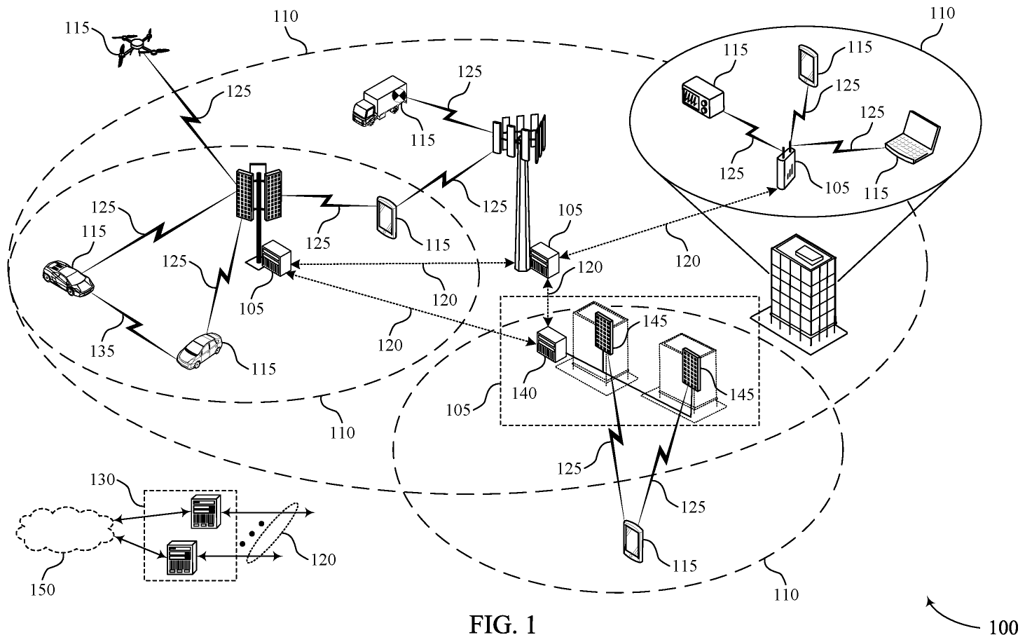

FIG. 1 illustrates an example of a wireless communications system 100 that supports UCI multiplexing rule for simultaneous uplink control channel and uplink shared channel transmission in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T_{S}=1/(Δfₘₐₓ·N_{f} ) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may receive one or more DCI messages from a base station 105 via one or more component carriers, or serving cells. For example, the UE 115 may receive DCI associated with an uplink shared channel (e.g., a PUSCH) transmission and DCI associated with a downlink shared channel (e.g., a PDSCH) transmission. The UE 115 may attempt to transmit UCI (e.g., a feedback message in response to the PDSCH transmission, a scheduling request, a CSI report, or the like) on an uplink control channel (e.g., a PUCCH) and an uplink signal (e.g., including control information or data) on the PUSCH. In some cases, the UE 115 may multiplex at least a portion of the UCI and the uplink signal on the PUSCH when resources, such as time-frequency resources, associated with the PUCCH overlap with resources associated with the PUSCH. In some cases, the UE 115 may multiplex feedback information (e.g., a HARQ acknowledgement (ACK)) from the UCI in the PUSCH transmission. Additionally or alternatively, the UE 115 may multiplex a CSI report in the PUSCH transmission.

In some other cases, the resources associated with the PUCCH may not overlap with the resources associated with the PUSCH. The UE 115 may multiplex feedback information (e.g., with or without a scheduling request) and one or more CSI reports in a same PUCCH based on a configuration indication from a base station 105. Thus, the UE 115 may multiplex UCI associated with a PUCCH in a PUSCH when resources associated with the PUCCH overlap with the resources associated with the PUSCH or may multiplex UCI in a same PUCCH if the resources associated with the PUCCH do not overlap with the resources associated with the PUSCH. However, the capability of the UE 115 to multiplex the UCI in the PUSCH may be limited. For example, the UE 115 may multiplex acknowledgement feedback information, CSI, or both in the PUSCH, and may drop the PUCCH, including any other UCI that would have been transmitted on the PUCCH, which may cause inefficient communication (e.g., due to retransmission of UCI).

The wireless communications system 100 may support the use of techniques that enable a UE 115 to determine a capability to support a mode of UCI transmission corresponding to transmitting the UCI on a PUCCH and an uplink signal on a PUSCH when the resources of the PUCCH and the resources of the PUSCH are at least partially overlapping, which may improve reliability (e.g., coverage) at the UE 115. In some cases, the UE 115 may be capable of performing one or more modes of UCI transmission. For example, in a UCI transmission mode, the UE 115 may transmit UCI on a PUCCH with resources (e.g., time-frequency resources) that overlap with a PUSCH. In another UCI transmission mode, the UE 115 may multiplex the UCI in the PUSCH and, in some cases, may drop the PUCCH.

In some cases, the UE 115 may transmit an indication of the capability to a base station 105. In some examples, the base station 105 may transmit a configuration indicating to the UE 115 to use a UCI transmission mode. The UE 115 may transmit UCI on the PUCCH and uplink signal on the PUSCH based on the configuration from the base station 105. In some cases, the base station 105 may transmit the configuration to the UE 115 via RRC signaling. In some examples, the UE 115 may receive an RRC configuration from the base station 105 if a serving cell of the PUCCH is not configured with a TCI state (e.g., the PUCCH may lack a beam configuration). In some cases, the PUCCH and the PUSCH may be associated with the same serving cell. In some other cases, the PUCCH and the PUSCH may be associated with different serving cells.

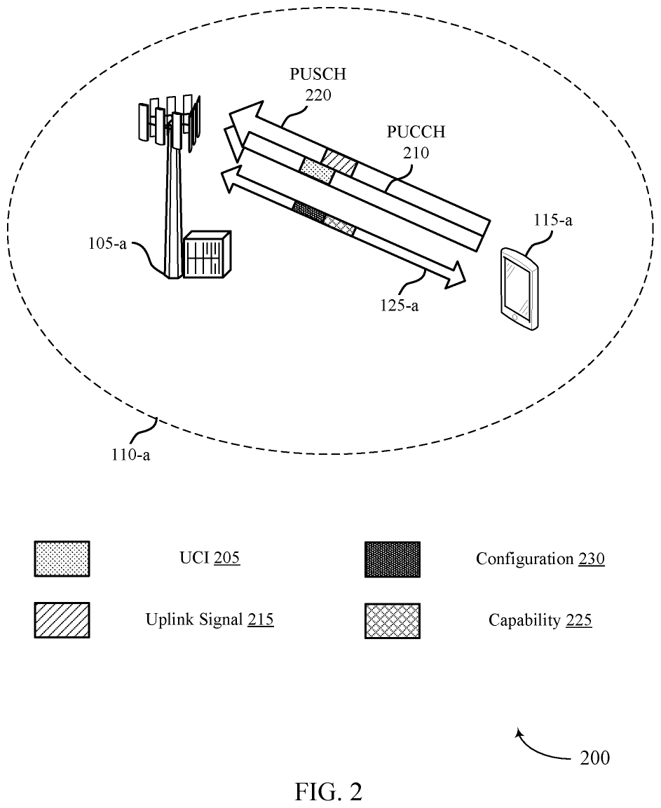

FIG. 2 illustrates an example of a wireless communications system 200 that supports UCI multiplexing rule for simultaneous uplink control channel and uplink shared channel transmission in accordance with aspects of the present disclosure. In some examples, wireless communications system 200 may implement aspects of wireless communication system 100 and may include UE 115-a, base station 105-a with coverage area 110-a, and communication link 125-a, which may be examples of a UE 115, a base station 105, and a communication link 125 as described with reference to FIG. 1. As described herein, a UE 115 may determine a capability associated with a transmission of UCI 205 to a base station 105, which may improve reliability at the UE 115 (e.g., due to increased coverage related to frequency and less dropping of CSI reports) at the UE 115.

In some examples, a UE 115 may receive one or more DCI messages from a base station 105 via one or more component carriers, or serving cells. For example, UE 115-a may receive DCI associated with an uplink shared channel transmission and DCI associated with a downlink shared channel (e.g., a PDSCH) transmission. The DCI messages may be associated with different cells or the same cell. The UE 115 may attempt to transmit UCI 205 (e.g., a feedback message in response to the PDSCH transmission, a scheduling request, a CSI report, or the like) on an uplink control channel (e.g., a PUCCH 210) and an uplink signal 215 (e.g., including control information or data) on an uplink shared channel (e.g., a PUSCH 220) based on one of the one or more DCI messages. In some cases, the UE 115 may multiplex at least a portion of the UCI 205 and the uplink signal 215 on an uplink channel (e.g., the PUSCH 220) due to minimum processing times associated with the PUCCH transmission and PUSCH transmission.

In some cases, a UE 115 may multiplex UCI 205 when resources, such as time-frequency resources, associated with an uplink control channel (e.g., a PUCCH 210) overlap with resources associated with an uplink shared channel (e.g., a PUSCH 220). For example, the UE 115 may multiplex UCI 205 in a PUCCH transmission that overlaps with a PUSCH transmission. In some cases, the UE 115 may multiplex feedback information (e.g., a HARQ ACK) from the UCI 205 in the PUSCH transmission. Additionally or alternatively, the UE 115 may multiplex a CSI report in the PUSCH transmission. In some cases, the CSI report may be a periodic CSI report, an aperiodic CSI report, or a semi-persistent CSI report. In some cases, such as if the UE 115 multiplexes UCI 205 in the PUSCH transmission, the UE 115 may not transmit on the PUCCH 210. The UE 115 may not transmit a scheduling request if feedback information and one or more CSI reports are multiplexed in the PUSCH transmission.

In some other cases, the resources associated with the PUCCH 210 may not overlap with the resources associated with the PUSCH 220. The UE 115 may multiplex feedback information (e.g., with or without a scheduling request) and one or more CSI reports in a same PUCCH 210 based on a configuration indication (e.g., simultaneous HARQ-ACK-CSI). In some examples, the UE 115 may be configured with, or may determine to use, one or more PUCCH resources in a slot to transmit the one or more CSI reports. For example, the base station 105 may not provide the UE 115 with a multiple CSI report configuration indication (e.g., multi-CSI-PUCCH-ResourceList), or the PUCCH resources for a transmission of CSI reports may not overlap in a slot, so the UE 115 may use a resource corresponding to a CSI report with the highest priority relative to the other CSI reports of the one or more CSI reports. In some other examples, the base station 105 may provide the UE 115 with a multiple CSI report configuration indication, or the PUCCH resources for the transmission of CSI reports may overlap in the slot, the UE 115 may multiplex the one or more CSI reports in a resource from the resource provided by the indication. In some cases, the UE 115 may not transmit more than one PUCCH 210 with feedback information per slot.

Thus, the UE 115 may multiplex UCI 205 associated with a PUCCH 210 in a PUSCH 220 when resources associated with the PUCCH 210 overlap with the resources associated with the PUSCH 220 or may multiplex UCI 205 in a same PUCCH 210 if the resources associated with the PUCCH 210 do not overlap with the resources associated with the PUSCH 220. However, the capability of the UE 115 to multiplex the UCI 205 in the PUSCH 220 may be limited. For example, the UE 115 may multiplex acknowledgement feedback information, CSI, or both in the PUSCH 220, and may drop the PUCCH 210, including any other UCI 205 that would have been transmitted on the PUCCH 210, which may cause inefficient communication (e.g., due to retransmission of UCI 205).

The wireless communications system 200 may support the use of techniques that enable a UE 115 to determine a capability to support a mode of UCI transmission corresponding to transmitting the UCI 205 on a PUCCH 210 and an uplink signal 215 on a PUSCH 220 when the resources of the PUCCH 210 and the resources of the PUSCH 220 are at least partially overlapping in time, which may improve reliability (e.g., coverage) at the UE 115. In some cases, UE 115-a may be capable of performing one or more modes of UCI transmission. For example, in a UCI transmission mode, UE 115-a may transmit UCI 205 on a PUCCH 210 with resources (e.g., time-frequency resources) that overlap with a PUSCH 220 and may also transmit the overlapped PUSCH 220. In another UCI transmission mode, UE 115-a may multiplex the UCI 205 in the PUSCH 220 and, in some cases, may drop the PUCCH 210.

In some cases, UE 115-a may transmit an indication of the capability 225 to base station 105-a via communication link 125-a. For example, UE 115-a may transmit the capability 225 as a parameter (e.g., sim-PUCCH-PUSCH-UL) in a UE capability report. The parameter may be included as a bit in the UE capability report or may be reported with another UE capability. In some examples, base station 105-a may transmit a configuration 230 indicating to UE 115-a to use a UCI transmission mode via communication link 125-a. For example, UE 115-a may transmit the UCI 205 on PUCCH 210 and uplink signal 215 on PUSCH 220 based on the configuration 230 of the UCI transmission mode from base station 105-a. In some cases, base station 105-a may transmit the configuration 230 to UE 115-a via RRC signaling. Additionally or alternatively, base station 105-a may transmit the configuration 230 to UE 115-a via a MAC-control element (MAC-CE) or DCI. Base station 105-a may include a parameter in the RRC signaling (e.g., sim-PUCCH-PUSCH) and may enable a transmission mode at UE 115-a based on adjusting the parameter. That is, if the configuration is set to enabled, UE 115-a may transmit the UCI 205 on the PUCCH 210 and the uplink signal 215 on the PUSCH 220 concurrently when the PUCCH 210 and the PUSCH 220 are overlapping at least partially in time. However, if the configuration is disabled, or the RRC parameter is not configured by base station 105-a, UE 115-a may multiplex the UCI 205 in the PUSCH 220 and, in some cases, may drop the PUCCH 210. In some examples, UE 115-a may receive an RRC configuration from base station 105-a if a serving cell of the PUCCH 210 is not configured with a TCI state (e.g., the PUCCH 210 may lack a beam configuration).

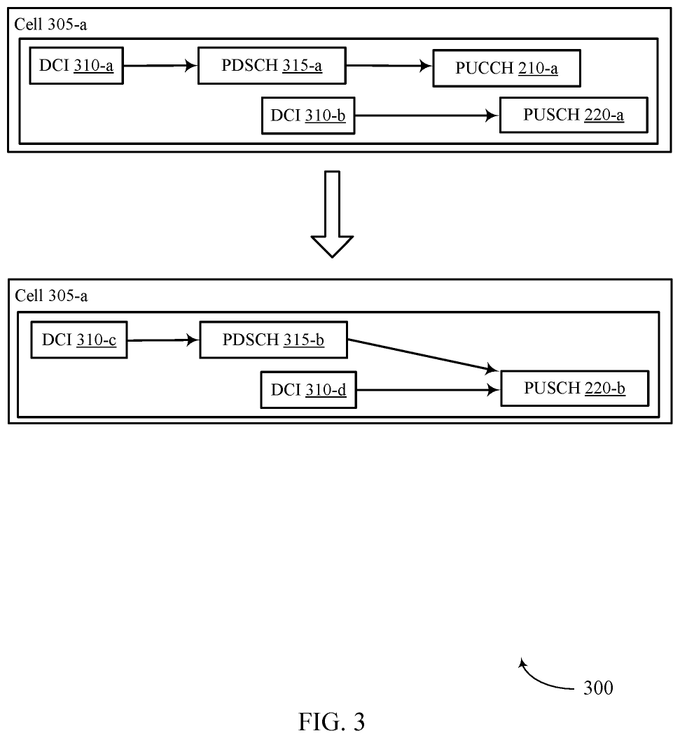

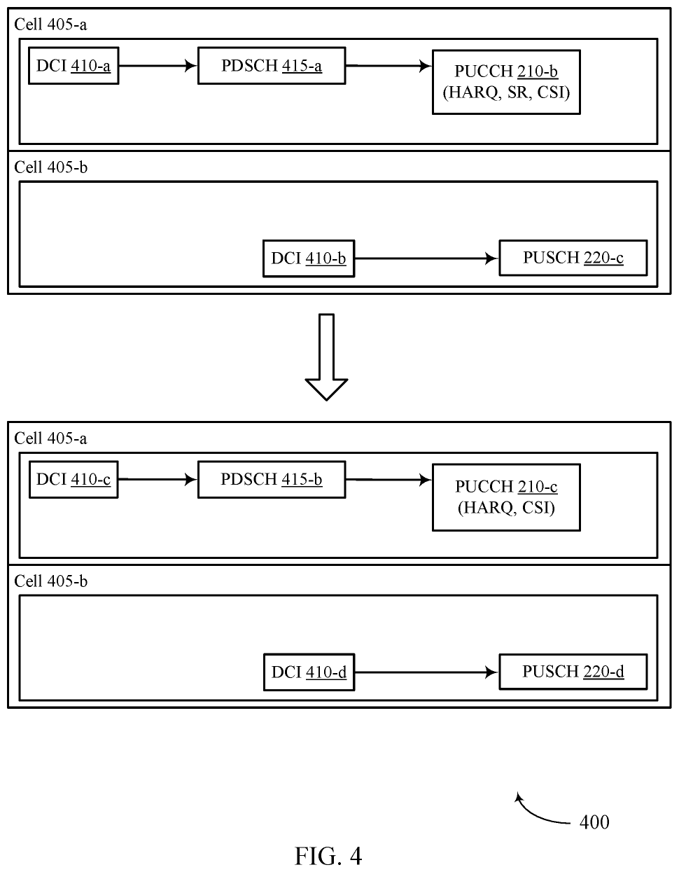

In some cases, the PUCCH 210 and the PUSCH 220 may be associated with the same serving cell, which is described in further detail with respect to FIG. 3. In some other cases, the PUCCH 210 and the PUSCH 220 may be associated with different serving cells, which is described in further detail with respect to FIG. 4. In some cases, the serving cell of the PUCCH 210 may be associated with Frequency Range 1 (FR1) and the serving cell of the PUSCH 220 may be associated with Frequency Range 2 (FR2). In some examples, transmissions on FR1 may have improved coverage and reliability when compared with transmissions on FR2 (e.g., because FR1 may have better coverage and may be more robust than FR2). For example, transmitting the UCI 205 on the PUCCH 210 instead of transmitting the UCI 205 on the PUSCH 220 may improve signaling reliability at UE 115-a. Additionally or alternatively, when a periodic CSI report or a semi-periodic CSI report on the PUCCH 210 is triggered for a serving cell (e.g., a serving cell associated with the PUCCH 210) and an aperiodic CSI report on the PUSCH 220 is triggered for another serving cell (e.g., a serving cell associated with the PUSCH 220), transmitting the UCI 205 on the PUCCH 210 instead of transmitting the UCI 205 on the PUSCH 220 may avoid dropping the CSI report on the PUCCH 210. Thus, transmitting the UCI 205 on the PUCCH 210 may improve signaling overhead (e.g., due to fewer retransmissions of CSI reports).

FIG. 3 illustrates an example of a processing timeline 300 that supports UCI multiplexing rule for simultaneous uplink control channel and uplink shared channel transmission in accordance with aspects of the present disclosure. In some examples, processing timeline 300 may implement aspects of wireless communication system 100, wireless communications system 200, or both and may include PUCCH 210-a, PUSCH 220-a, and PUSCH 220-b, which may be examples of a PUCCH 210 and PUSCHs 220 as described with reference to FIG. 2. The process illustrated by processing timeline 300 may be implemented at a UE 115 or a base station 105 as described with reference to FIGS. 1 and 2. For example, the processing timeline 300 may illustrate a method in which a UE 115 may transmit one or more uplink transmissions during a PUCCH 210, a PUSCH 220, or both. In some cases, processing timeline 300 may be associated with a single serving cell 305-a (e.g., a single component carrier).

In some examples, a UE 115 may receive one or more messages including DCI 310 from a base station 105 via one or more component carriers, or serving cells, as described with reference to FIG. 2. For example, the UE 115 may receive DCI 310-a through DCI 310-d, which may be associated with cell 305-a. In some examples, DCI 310-a and DCI 310-c may be associated with a transmission on a downlink shared channel (e.g., PDSCH 315-a and PDSCH 315-b respectively). The UE 115 may transmit a feedback message, such as an ACK or a negative acknowledgement (NACK), to the base station 105 in response to receiving the PDSCH 315. The UE 115 may transmit the feedback message as a portion of UCI 205, which may be an example of UCI 205 as described with reference to FIG. 2, in an uplink control channel (e.g., PUCCH 210-a). In some cases, the UE 115 may also transmit a CSI report, a scheduling request, or both as a portion of the UCI 205 in PUCCH 210-a. In some cases, DCI 310-b and DCI 310-d may be associated with an uplink signal (e.g., control information or data) to be transmitted in PUSCH 220-a and PUSCH 220-b respectively. The UE 115 may wait for a processing time after receiving PDSCH 315-a and DCI 310-b. However, in some cases, resources associated with PUCCH 210-a and PUSCH 220-a may overlap. For example, PUCCH 210-a and PUSCH 220-a may overlap in time, which may cause the UE 115 to fail to meet timing conditions associated with uplink transmission.

In some cases, the UE 115 may multiplex the UCI 205, such as feedback information and CSI reports, on PUSCH 220-b based on determining a PUCCH 210 and PUSCH 220-b overlap in time. In some cases, the UE 115 may drop a scheduling request associated with the UCI 205 based on the overlapping PUSCH 220-b. In some examples, the UE 115 may multiplex CSI reports from the UCI 205 associated with a PUCCH 210 on PUSCH 220-b if PUSCH 220-b has no aperiodic CSI report or semi-persistent CSI report. Otherwise, if PUSCH 220-b has an aperiodic CSI report or a semi-persistent CSI report, the UE 115 may drop one or more CSI reports from the UCI 205 associated with the PUCCH 210 and may multiplex feedback information from the UCI 205 associated with the PUCCH 210 on PUSCH 220-b. A UE may not expect to multiplex the UCI 205 in a PUSCH transmission in one slot with subcarrier spacing configuration of the same type that the UE 115 would transmit in PUCCHs in different slots with a different subcarrier spacing. In some cases, the UE 115 may transmit a PUCCH 210 and a PUSCH 220 if the resources do not overlap on the same cell 305, which may improve latency associated with processing times, as described in further detail with respect to FIG. 4.

FIG. 4 illustrates an example of a processing timeline 400 that supports a UCI multiplexing rule for simultaneous uplink control channel and uplink shared channel transmission in accordance with aspects of the present disclosure. In some examples, processing timeline 400 may implement aspects of wireless communication system 100, wireless communications system 200, or both as well as processing timeline 300. Processing timeline 400 may include PUCCH 210-b, PUCCH 210-c, PUSCH 220-c, PUSCH 220-d, which may be examples of PUCCHs 210 and PUSCHs 220 as described with reference to FIG. 2. The process illustrated by processing timeline 400 may be implemented at a UE 115 or a base station 105 as described with reference to FIGS. 1 and 2. For example, the processing timeline 400 may illustrate a method in which a UE 115 may transmit one or more uplink transmissions during a PUCCH 210, a PUSCH 220, or both. In some cases, processing timeline 300 may be associated with multiple serving cells (e.g., serving cell 405-a and serving cell 405-b).

In some examples, a UE 115 may receive one or more messages including DCI 410 from a base station 105 via one or more component carriers, or serving cells, as described with reference to FIGS. 2 and 3. For example, the UE 115 may receive DCI 410-a through DCI 410-d from the base station 105. In some cases, DCI 410-a and DCI 410-c may be associated with cell 405-a and DCI 410-b and DCI 410-d may be associated with cell 405-b. In some examples, DCI 410-a and DCI 410-c may be associated with a transmission on a downlink shared channel (e.g., PDSCH 415-a and PDSCH 415-b respectively). The UE 115 may transmit a feedback message, such as an ACK or a NACK, to the base station 105 in response to receiving the PDSCH 415. The UE 115 may transmit the feedback message as a portion of UCI 205, which may be an example of UCI 205 as described with reference to FIG. 2, in an uplink control channel (e.g., a PUCCH 210). In some cases, the UE 115 may also transmit a CSI report, a scheduling request, or both as a portion of the UCI 205 in the PUCCH 210. In some cases, DCI 410-b and DCI 410-d may be associated with an uplink signal (e.g., control information or data) to be transmitted in PUSCH 220-c and PUSCH 220-d respectively.

The UE 115 may wait for a processing time after receiving PDSCH 415-a and DCI 410-b. In some cases, the resources associated with PUCCH 210-b may overlap in time with the resources associated with PUSCH 220-c on another serving cell. For example, the resources associated with PUCCH 210-b and PUCCH 210-c corresponding to cell 405-a may overlap in time with resources associated with PUSCH 220-c and PUSCH 220-d corresponding to cell 405-b. In some cases, the UE 115 may transmit UCI (e.g., including feedback information such as a HARQ ACK, one or more CSI reports, a scheduling request, or a combination) on PUCCH 210-b or PUCCH 210-c and may transmit an uplink signal on PUSCH 220-c or PUSCH 220-d. In some cases, for example if a PUCCH 210 overlaps in time with another PUSCH transmission, the UE 115 may refrain from transmitting the scheduling request. That is, if a transmission on PUSCH 220-d overlaps in time with PUCCH 210-c, the UE 115 may transmit PUSCH 220-d and PUCCH 210-c concurrently. In some examples, the UE 115 may not transmit a scheduling request on PUCCH 210-c. In some cases, the UE 115 may transmit an aperiodic CSI report or semi-persistent CSI report on PUCCH 210-c regardless of whether PUSCH 220-d has an aperiodic CSI report or semi-persistent CSI report.

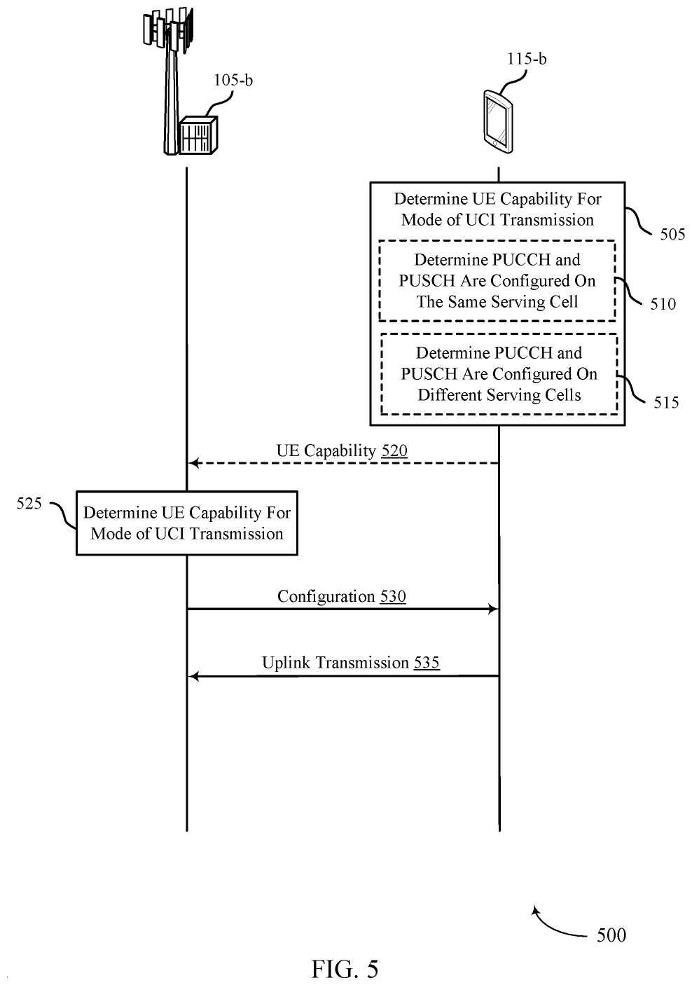

FIG. 5 illustrates an example of a process flow 500 that supports UCI multiplexing rule for simultaneous uplink control channel and uplink shared channel transmission in accordance with aspects of the present disclosure. In some examples, process flow 500 may implement aspects of wireless communications systems 100 and 200. The process flow 500 may illustrate an example of a UE 115, such as UE 115-b, determining a capability to perform a mode of UCI transmission and transmitting an uplink transmission to a base station 105, such as base station 105-b, based on the capability. Alternative examples of the following may be implemented, where some processes are performed in a different order than described or are not performed. In some cases, processes may include additional features not mentioned below, or further processes may be added.

At 505, UE 115-b may determine a capability of the UE 115-b to perform at least a first mode of UCI transmission and a second mode of UCI transmission. In some cases, the first mode may correspond to transmitting UCI on an uplink control channel (e.g., a PUCCH) and transmitting an uplink signal on an uplink shared channel (e.g., a PUSCH) concurrently such that the PUCCH overlaps at least partially in time with the PUSCH. In some examples, the second mode may correspond to transmitting UCI from a PUCCH and an uplink signal on a PUSCH when the PUCCH overlaps at least partially in time with the PUSCH. In some cases, the UCI may include a feedback information (e.g., a HARQ ACK), a CSI report (e.g., a periodic CSI report, an aperiodic CSI report, or a semi-persistent CSI report), a scheduling request, or a combination.

At 510, UE 115-b may determine the PUCCH and the PUSCH are configured on a same serving cell. In some cases, UE 115-b may determine the capability at 505 based on the PUCCH and the PUSCH on the same serving cell. In some cases, UE 115-b may determine the PUCCH and the PUSCH overlap at least partially during a time period, where the PUCCH and the PUSCH are on the same serving cell. In some examples, UE 115-b may drop a scheduling request based on the PUCCH overlapping with the PUSCH during the time period. Additionally or alternatively, UE 115-b may determine an absence of a type of CSI reporting on the PUSCH during the time period (e.g., an aperiodic CSI report or a semi-persistent CSI report). UE 115-b may multiplex a CSI report (e.g., another type of CSI report, such as a periodic CSI report) based on the absence.

At 515, UE 115-b may determine the PUCCH and the PUSCH are configured on different serving cells (e.g., a first serving cell and a second serving cell different than the first). In some cases, UE 115-b may determine the capability at 505 based on the PUCCH and PUSCH on different serving cells. In some cases, UE 115-b may determine the PUCCH does not overlap in time with the PUSCH during a time period. UE 115-b may transmit a scheduling request based on the PUCCH not overlapping with the PUSCH during the time period.

At 520, UE 115-b may transmit an indication of the determined capability to base station 105-b. At 525, base station 105-b may determine the capability of the UE 115-b to perform at least the first mode of UCI transmission and the second mode of UCI transmission.

At 530, base station 105-b may transmit a configuration to UE 115-b, the configuration indicating that UE 115-b is to use the first mode of UCI transmission. In some cases, UE 115-b may receive the configuration based on the PUCCH lacking a beam configuration (i.e., a TCI state). For example, the serving cell with PUCCH may be configured on FR1. In some cases, base station 105-b may transmit the configuration via RRC signaling, a MAC-CE, or DCI.

At 535, UE 115-b may transmit the UCI on the PUCCH and an uplink signal on the PUSCH based on receiving the configuration. In some examples, the uplink signal may include control information, data or both.

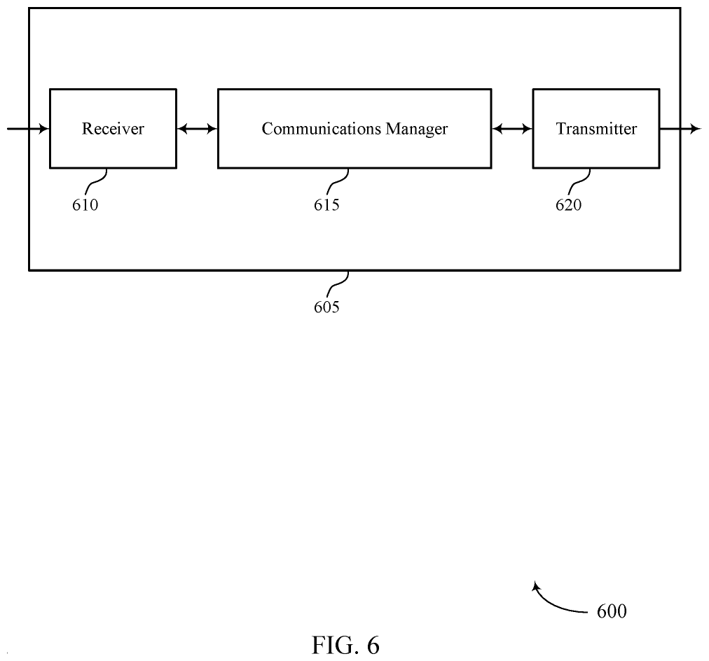

FIG. 6 shows a block diagram 600 of a device 605 that supports a UCI multiplexing rule for simultaneous uplink control channel and uplink shared channel transmission in accordance with aspects of the present disclosure. The device 605 may be an example of aspects of a UE 115 as described herein. The device 605 may include a receiver 610, a communications manager 615, and a transmitter 620. The device 605 may also include one or more processors, memory coupled with the one or more processors, and instructions stored in the memory that are executable by the one or more processors to enable the one or more processors to perform the UCI multiplexing rule uplink transmission features discussed herein. Each of these components may be in communication with one another (e.g., via one or more buses).

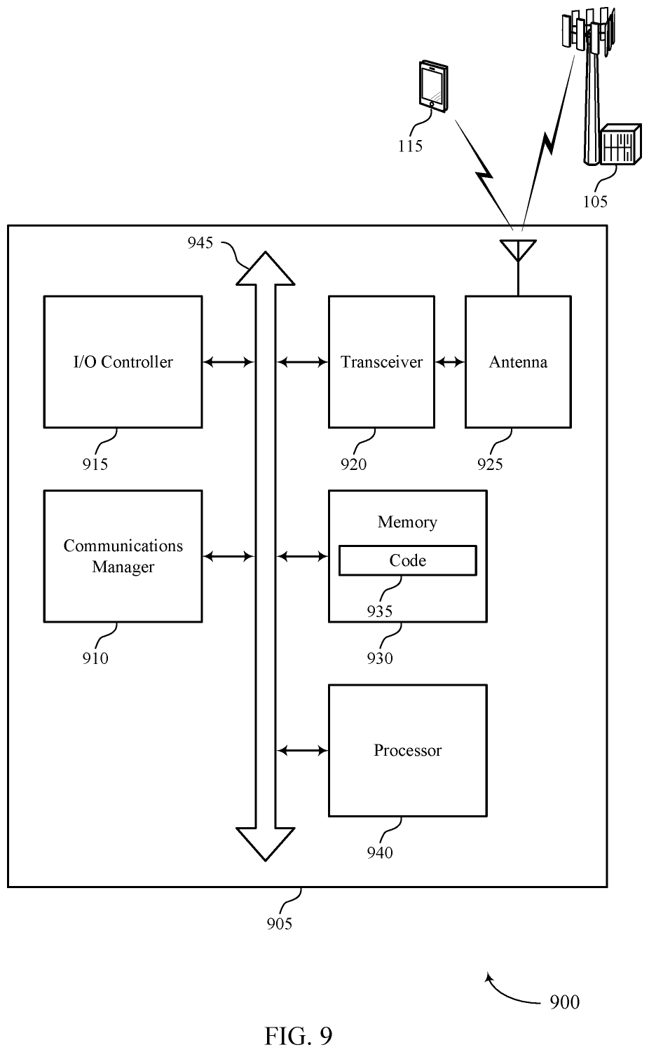

The receiver 610 may receive information such as packets, user data, or control information associated with various information channels (e.g., control channels, data channels, and information related to UCI multiplexing rule for simultaneous uplink control channel and uplink shared channel transmission, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receive, from a base station, a configuration indicating that the UE is to use the first mode of UCI transmission, and transmit, based on the received configuration, the UCI on the uplink control channel and an uplink signal on the uplink shared channel. The communications manager 615 may be an example of aspects of the communications manager 910 described herein.

The actions performed by the communications manager 615 as described herein may be implemented to realize one or more potential advantages. One implementation may enable a UE to determine a capability for transmitting UCI on a PUCCH and an uplink signal on a PUSCH. The UE may transmit the UCI on the PUCCH, which may result in improved signaling reliability (e.g., better coverage) at the UE, among other advantages.

Based on implementing the UCI transmission capability as described herein, a processor of a UE or base station (e.g., a processor controlling the receiver 610, the communications manager 615, the transmitter 620, or a combination thereof) may reduce the impact or likelihood of unnecessary monitoring while ensuring relatively efficient communications. For example, the capability based UCI transmission as described herein may leverage a PUCCH and a PUSCH that overlap at least partially in time to transmit a UCI and an uplink signal respectively, which may realize reduced signaling overhead (e.g., due to less dropping of CSI reports), among other benefits.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field-programmable gate-array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

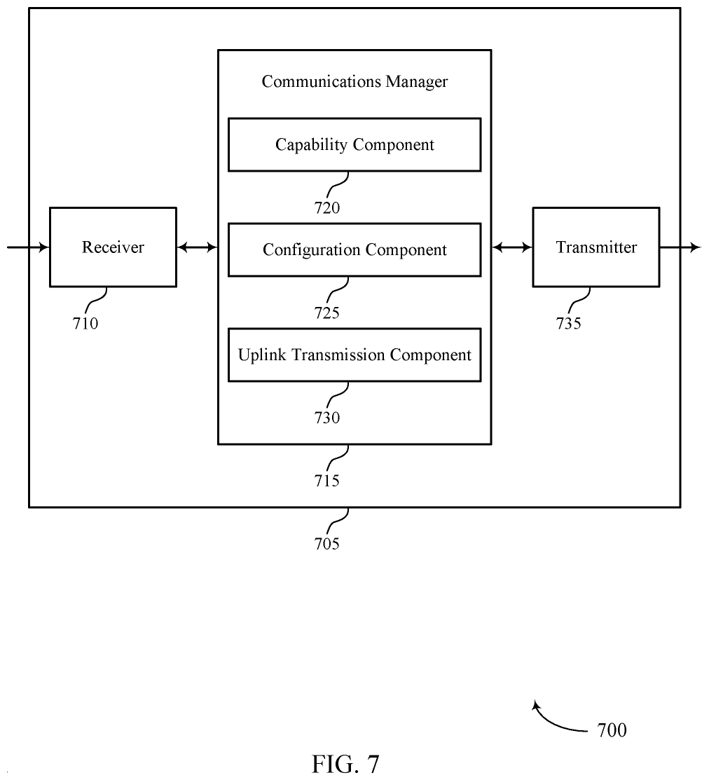

FIG. 7 shows a block diagram 700 of a device 705 that supports UCI multiplexing rule for simultaneous uplink control channel and uplink shared channel transmission in accordance with aspects of the present disclosure. The device 705 may be an example of aspects of a device 605, or a UE 115 as described herein. The device 705 may include a receiver 710, a communications manager 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to UCI multiplexing rule for simultaneous uplink control channel and uplink shared channel transmission, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a capability component 720, a configuration component 725, and an uplink transmission component 730. The communications manager 715 may be an example of aspects of the communications manager 910 described herein.

The capability component 720 may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel. The configuration component 725 may receive, from a base station, a configuration indicating that the UE is to use the first mode of UCI transmission. The uplink transmission component 730 may transmit, based on the received configuration, the UCI on the uplink control channel and an uplink signal on the uplink shared channel.

The transmitter 735 may transmit signals generated by other components of the device 705. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

In some cases, the capability component 720, the configuration component 725, and the uplink transmission component 730, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 720, the configuration component 725, and the uplink transmission component 730 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

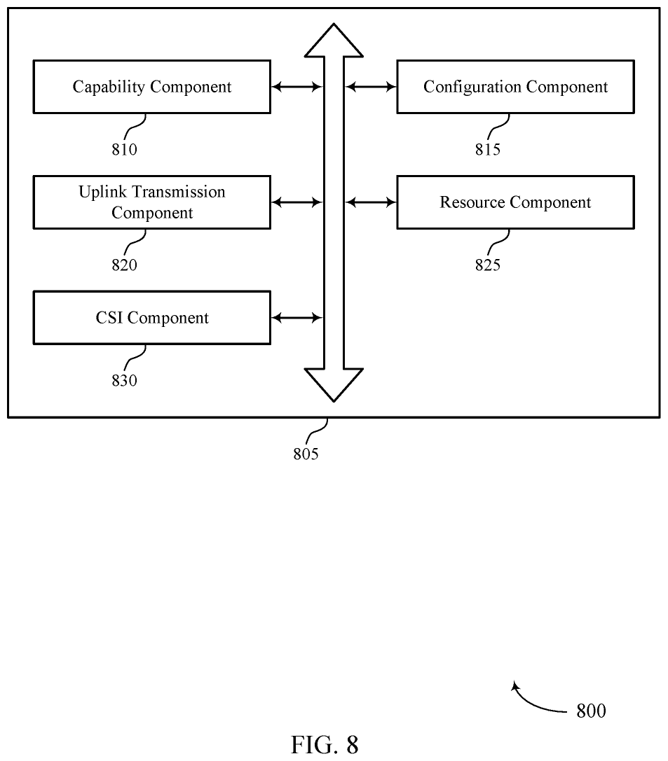

FIG. 8 shows a block diagram 800 of a communications manager 805 that supports UCI multiplexing rule for simultaneous uplink control channel and uplink shared channel transmission in accordance with aspects of the present disclosure. The communications manager 805 may be an example of aspects of a communications manager 615, a communications manager 715, or a communications manager 910 described herein. The communications manager 805 may include a capability component 810, a configuration component 815, an uplink transmission component 820, a resource component 825, and a CSI component 830. Each of these modules may communicate, directly or indirectly, with one another (e.g., via one or more buses).

The capability component 810 may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel. In some examples, the capability component 810 may transmit, to the base station, an indication of the determined capability.

In some examples, the capability component 810 may determine that the uplink control channel and the uplink shared channel are configured on a same serving cell, where the capability of the UE is determined based on the uplink control channel and the uplink shared channel being configured on the same serving cell. In some examples, the capability component 810 may determine that the uplink control channel is configured on a first serving cell and the uplink shared channel is configured on a second serving cell different than the first serving cell, where the capability of the UE is determined based on the uplink control channel being configured on a different serving cell than the uplink shared channel.

The configuration component 815 may receive, from a base station, a configuration indicating that the UE is to use the first mode of UCI transmission. In some cases, the configuration component 815 may receive the configuration based on the uplink control channel lacking a beam configuration. In some examples, the configuration component 815 may receive the configuration via RRC signaling. The uplink transmission component 820 may transmit, based on the received configuration, the UCI on the uplink control channel and an uplink signal on the uplink shared channel.

The resource component 825 may determine that the uplink control channel overlaps in time at least in part with the uplink shared channel during a time period, where the uplink control channel and the uplink shared channel are configured on the same serving cell. In some examples, the resource component 825 may drop a scheduling request based on the uplink control channel overlapping with the uplink shared channel during the time period.

The CSI component 830 may determine an absence of a second type of CSI reporting during the time period. In some examples, the CSI component 830 may multiplex a first type of CSI reporting based on the absence of the second type of CSI reporting. In some cases, the first type of CSI reporting is periodic and the second type of CSI is aperiodic or semi-persistent.

In some examples, the resource component 825 may determine the uplink control channel does not overlap in time with the uplink shared channel during a time period. In some examples, the resource component 825 may transmit, to the base station, a scheduling request based on the uplink control channel not overlapping in time with the uplink shared channel during the time period.

In some cases, the capability component 810, the configuration component 815, the uplink transmission component 820, the resource component 825, and the CSI component 830 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 810, the configuration component 815, the uplink transmission component 820, the resource component 825, and the CSI component 830 discussed herein.

FIG. 9 shows a diagram of a system 900 including a device 905 that supports UCI multiplexing rule for simultaneous uplink control channel and uplink shared channel transmission in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel, receive, from a base station, a configuration indicating that the UE is to use the first mode of UCI transmission, and transmit, based on the received configuration, the UCI on the uplink control channel and an uplink signal on the uplink shared channel.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting UCI multiplexing rule for simultaneous uplink control channel and uplink shared channel transmission).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

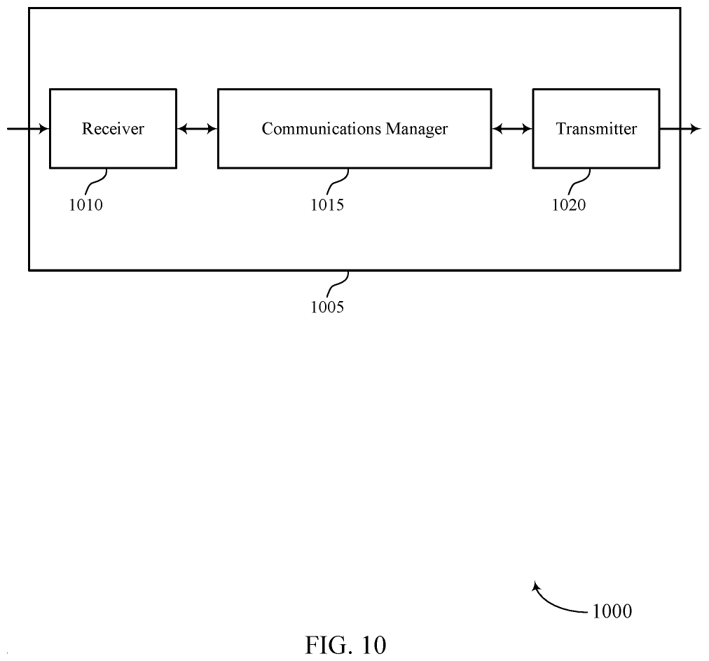

FIG. 10 shows a block diagram 1000 of a device 1005 that supports UCI multiplexing rule for simultaneous uplink control channel and uplink shared channel transmission in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

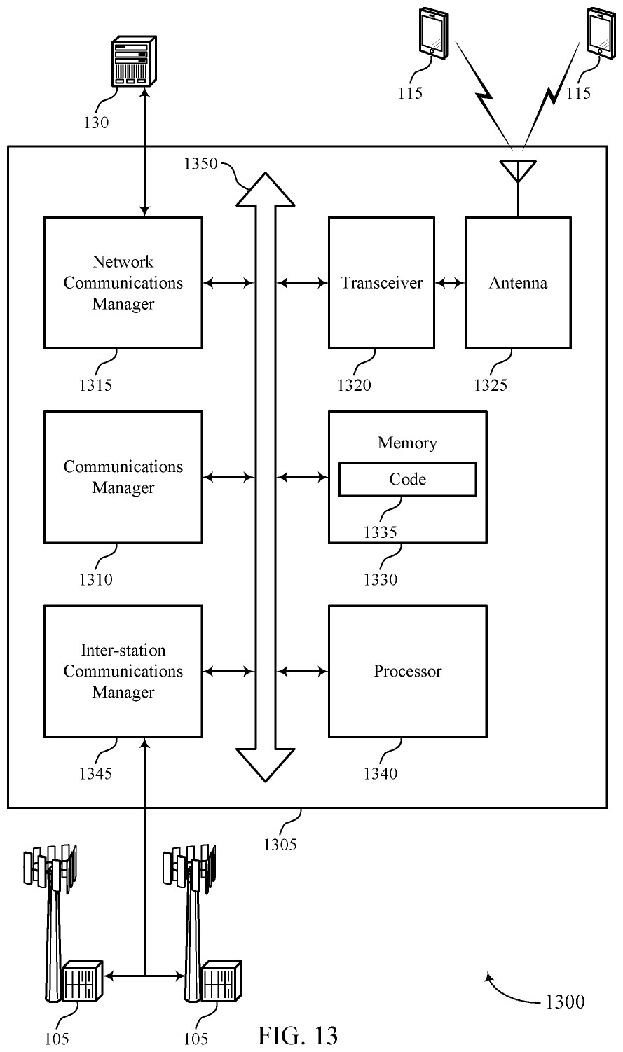

The receiver 1010 may receive information such as packets, user data, or control information associated with various information channels (e.g., control channels, data channels, and information related to UCI multiplexing rule for simultaneous uplink control channel and uplink shared channel transmission, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmit, to the UE, a configuration indicating that the UE is to use the first mode of UCI transmission, and receive, based on the transmitted configuration, the UCI on the uplink control channel and an uplink signal on the uplink shared channel. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

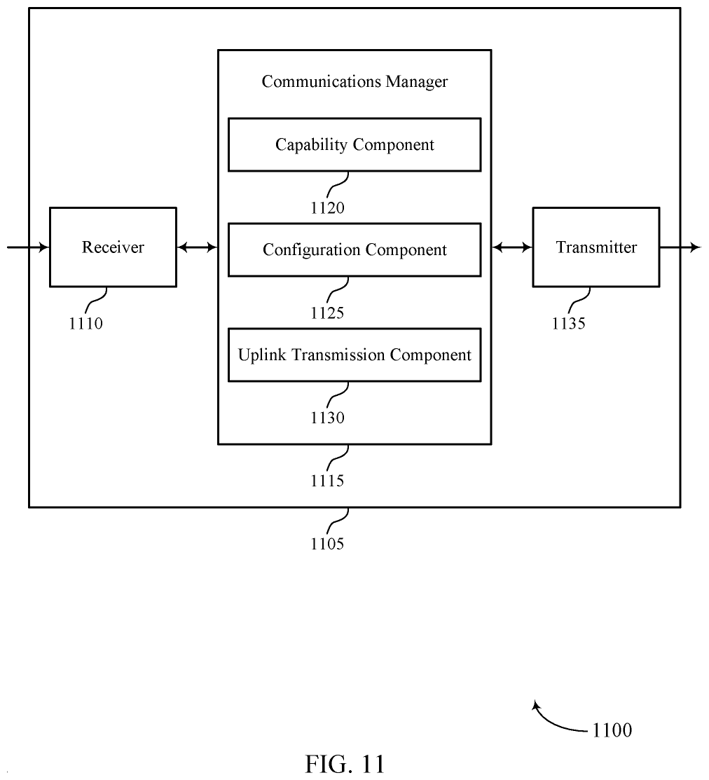

FIG. 11 shows a block diagram 1100 of a device 1105 that supports UCI multiplexing rule for simultaneous uplink control channel and uplink shared channel transmission in accordance with aspects of the present disclosure. The device 1105 may be an example of aspects of a device 1005, or a base station 105 as described herein. The device 1105 may include a receiver 1110, a communications manager 1115, and a transmitter 1135. The device 1105 may also include a processor. Each of these components may be in communication with one another (e.g., via one or more buses).

The receiver 1110 may receive information such as packets, user data, or control information associated with various information channels (e.g., control channels, data channels, and information related to UCI multiplexing rule for simultaneous uplink control channel and uplink shared channel transmission, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a capability component 1120, a configuration component 1125, and an uplink transmission component 1130. The communications manager 1115 may be an example of aspects of the communications manager 1310 described herein.

The capability component 1120 may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel. The configuration component 1125 may transmit, to the UE, a configuration indicating that the UE is to use the first mode of UCI transmission. The uplink transmission component 1130 may receive, based on the transmitted configuration, the UCI on the uplink control channel and an uplink signal on the uplink shared channel.

The transmitter 1135 may transmit signals generated by other components of the device 1105. In some examples, the transmitter 1135 may be collocated with a receiver 1110 in a transceiver module. For example, the transmitter 1135 may be an example of aspects of the transceiver 1320 described with reference to FIG. 13. The transmitter 1135 may utilize a single antenna or a set of antennas.

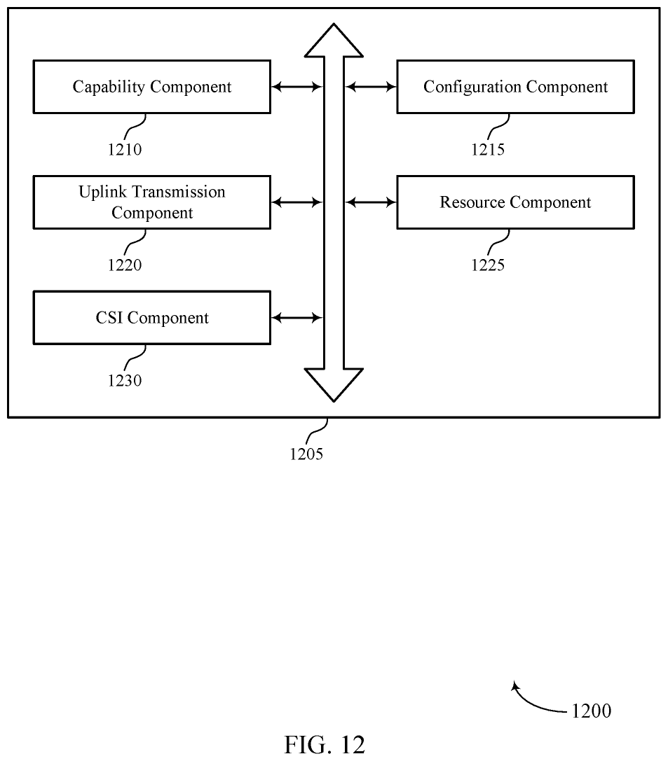

FIG. 12 shows a block diagram 1200 of a communications manager 1205 that supports UCI multiplexing rule for simultaneous uplink control channel and uplink shared channel transmission in accordance with aspects of the present disclosure. The communications manager 1205 may be an example of aspects of a communications manager 1015, a communications manager 1115, or a communications manager 1310 described herein. The communications manager 1205 may include a capability component 1210, a configuration component 1215, an uplink transmission component 1220, a resource component 1225, and a CSI component 1230. Each of these modules may communicate, directly or indirectly, with one another (e.g., via one or more buses).

The capability component 1210 may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel. In some examples, the capability component 1210 may receive, from the UE, an indication of the determined capability.

In some examples, the capability component 1210 may determine that the uplink control channel and the uplink shared channel are configured on a same serving cell, where the capability of the UE is determined based on the uplink control channel and the uplink shared channel being configured on the same serving cell. In some examples, the capability component 1210 may determine that the uplink control channel is configured on a first serving cell and the uplink shared channel is configured on a second serving cell different than the first serving cell, where the capability of the UE is determined based on the uplink control channel being configured on a different serving cell than the uplink shared channel.

The configuration component 1215 may transmit, to the UE, a configuration indicating that the UE is to use the first mode of UCI transmission. In some cases, the configuration component 1215 may transmit the configuration based on the uplink control channel lacking a beam configuration. In some examples, the configuration component 1215 may transmit the configuration via RRC signaling.

The uplink transmission component 1220 may receive, based on the transmitted configuration, the UCI on the uplink control channel and an uplink signal on the uplink shared channel.

The resource component 1225 may determine that the uplink control channel overlaps in time at least in part with the uplink shared channel during a time period, where the uplink control channel and the uplink shared channel are configured on the same serving cell. The CSI Component 1230 may receive, from the UE, a multiplexed transmission including a first type of CSI reporting based on an absence of a second type of CSI reporting. In some cases, the first type of CSI reporting is periodic and the second type of CSI is aperiodic or semi-persistent.

In some examples, the resource component 1225 may receive, from the UE, a scheduling request based on the uplink control channel not overlapping in time with the uplink shared channel during a time period.

FIG. 13 shows a diagram of a system 1300 including a device 1305 that supports UCI multiplexing rule for simultaneous uplink control channel and uplink shared channel transmission in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel, transmit, to the UE, a configuration indicating that the UE is to use the first mode of UCI transmission, and receive, based on the transmitted configuration, the UCI on the uplink control channel and an uplink signal on the uplink shared channel.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting UCI multiplexing rule for simultaneous uplink control channel and uplink shared channel transmission).

The inter-station communications manager 1345 may manage communications with other base station 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

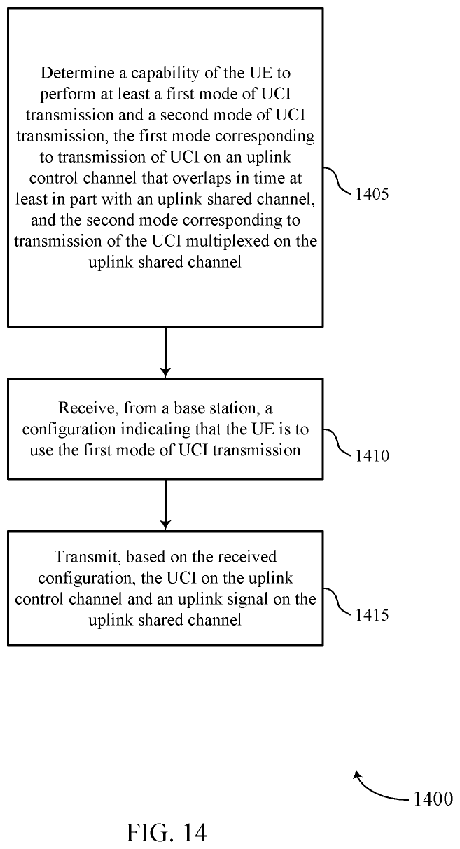

FIG. 14 shows a flowchart illustrating a method 1400 that supports UCI multiplexing rule for simultaneous uplink control channel and uplink shared channel transmission in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel. The operations of 1405 may be performed according to the methods described herein. In some examples, aspects of the operations of 1405 may be performed by a capability component as described with reference to FIGS. 6 through 9.

At 1410, the UE may receive, from a base station, a configuration indicating that the UE is to use the first mode of UCI transmission. The operations of 1410 may be performed according to the methods described herein. In some examples, aspects of the operations of 1410 may be performed by a configuration component as described with reference to FIGS. 6 through 9.

At 1415, the UE may transmit, based on the received configuration, the UCI on the uplink control channel and an uplink signal on the uplink shared channel. The operations of 1415 may be performed according to the methods described herein. In some examples, aspects of the operations of 1415 may be performed by an uplink transmission component as described with reference to FIGS. 6 through 9.

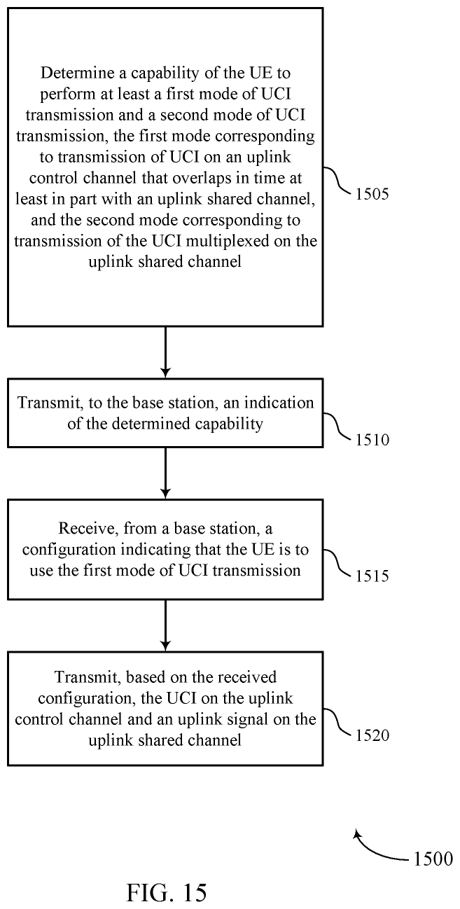

FIG. 15 shows a flowchart illustrating a method 1500 that supports UCI multiplexing rule for simultaneous uplink control channel and uplink shared channel transmission in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may determine a capability of the UE to perform at least a first mode of UCI transmission and a second mode of UCI transmission, the first mode corresponding to transmission of UCI on an uplink control channel that overlaps in time at least in part with an uplink shared channel, and the second mode corresponding to transmission of the UCI multiplexed on the uplink shared channel. The operations of 1505 may be performed according to the methods described herein. In some examples, aspects of the operations of 1505 may be performed by a capability component as described with reference to FIGS. 6 through 9.

At 1510, the UE may transmit, to the base station, an indication of the determined capability. The operations of 1510 may be performed according to the methods described herein. In some examples, aspects of the operations of 1510 may be performed by a capability component as described with reference to FIGS. 6 through 9.

At 1515, the UE may receive, from a base station, a configuration indicating that the UE is to use the first mode of UCI transmission. The operations of 1515 may be performed according to the methods described herein. In some examples, aspects of the operations of 1515 may be performed by a configuration component as described with reference to FIGS. 6 through 9.

At 1520, the UE may transmit, based on the received configuration, the UCI on the uplink control channel and an uplink signal on the uplink shared channel. The operations of 1520 may be performed according to the methods described herein. In some examples, aspects of the operations of 1520 may be performed by an uplink transmission component as described with reference to FIGS. 6 through 9.

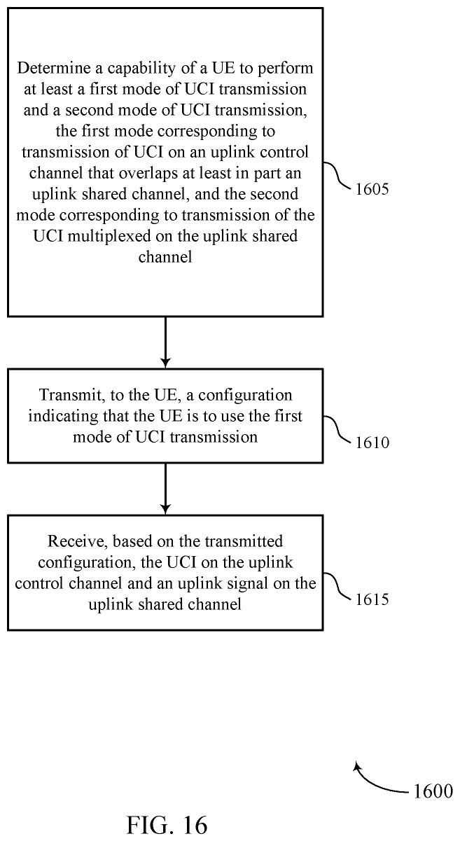

FIG. 16 shows a flowchart illustrating a method 1600 that supports UCI multiplexing rule for simultaneous uplink control channel and uplink shared channel transmission in accordance with aspects of the present disclosure. The operations of method 1600 may be implemented by a base station 105 or its components as described herein. For example, the operations of method 1600 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1605, the base station may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel. The operations of 1605 may be performed according to the methods described herein. In some examples, aspects of the operations of 1605 may be performed by a capability component as described with reference to FIGS. 10 through 13.

At 1610, the base station may transmit, to the UE, a configuration indicating that the UE is to use the first mode of UCI transmission. The operations of 1610 may be performed according to the methods described herein. In some examples, aspects of the operations of 1610 may be performed by a configuration component as described with reference to FIGS. 10 through 13.

At 1615, the base station may receive, based on the transmitted configuration, the UCI on the uplink control channel and an uplink signal on the uplink shared channel. The operations of 1615 may be performed according to the methods described herein. In some examples, aspects of the operations of 1615 may be performed by an uplink transmission component as described with reference to FIGS. 10 through 13.

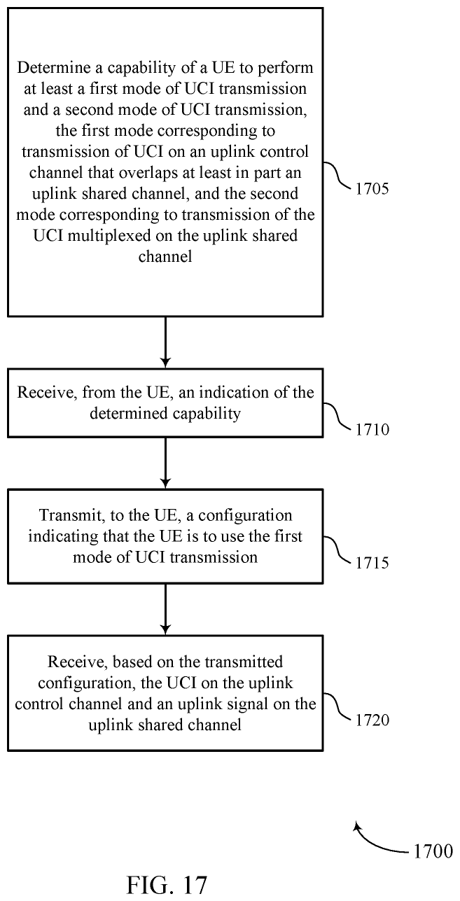

FIG. 17 shows a flowchart illustrating a method 1700 that supports UCI multiplexing rule for simultaneous uplink control channel and uplink shared channel transmission in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1705, the base station may determine a capability of a UE to perform at least a first mode of UCI transmission and a second mode of UCI transmission, the first mode corresponding to transmission of UCI on an uplink control channel that overlaps at least in part an uplink shared channel, and the second mode corresponding to transmission of the UCI multiplexed on the uplink shared channel. The operations of 1705 may be performed according to the methods described herein. In some examples, aspects of the operations of 1705 may be performed by a capability component as described with reference to FIGS. 10 through 13.

At 1710, the base station may receive, from the UE, an indication of the determined capability. The operations of 1710 may be performed according to the methods described herein. In some examples, aspects of the operations of 1710 may be performed by a capability component as described with reference to FIGS. 10 through 13.

At 1715, the base station may transmit, to the UE, a configuration indicating that the UE is to use the first mode of UCI transmission. The operations of 1715 may be performed according to the methods described herein. In some examples, aspects of the operations of 1715 may be performed by a configuration component as described with reference to FIGS. 10 through 13.

At 1720, the base station may receive, based on the transmitted configuration, the UCI on the uplink control channel and an uplink signal on the uplink shared channel. The operations of 1720 may be performed according to the methods described herein. In some examples, aspects of the operations of 1720 may be performed by an uplink transmission component as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
determining a capability of the UE to perform at least a first mode of uplink control information transmission and a second mode of uplink control information transmission, the first mode corresponding to transmission of uplink control information on an uplink control channel that overlaps in time at least in part with an uplink shared channel, and the second mode corresponding to transmission of the uplink control information multiplexed on the uplink shared channel;
receiving, from a base station, a configuration indicating that the UE is to use the first mode of uplink control information transmission; and
transmitting, based at least in part on the received configuration, the uplink control information on the uplink control channel and an uplink signal on the uplink shared channel.

2. The method of claim 1, further comprising:
transmitting, to the base station, an indication of the determined capability.

3. The method of claim 1, wherein the configuration is received based at least in part on the uplink control channel lacking a beam configuration.

4. The method of claim 1, further comprising:
determining that the uplink control channel and the uplink shared channel are configured on a same serving cell, wherein the capability of the UE is determined based at least in part on the uplink control channel and the uplink shared channel being configured on the same serving cell.

5. The method of claim 1, further comprising:
determining that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

6. The method of claim 1, further comprising:
determining that the uplink control channel overlaps in time at least in part with the uplink shared channel during a time period, wherein the uplink control channel and the uplink shared channel are configured on the same serving cell.

7. The method of claim 6, further comprising:
dropping a scheduling request based at least in part on the uplink control channel overlapping with the uplink shared channel during the time period.

8. The method of claim 6, further comprising:
determining an absence of a second type of channel state information reporting during the time period; and
multiplexing a first type of channel state information reporting based at least in part on the absence of the second type of channel state information reporting.

9. The method of claim 8, wherein the first type of channel state information reporting is periodic and the second type of channel state information is aperiodic or semi-persistent.

10. The method of claim 1, further comprising:
determining the uplink control channel does not overlap in time with the uplink shared channel during a time period; and
transmitting, to the base station, a scheduling request based at least in part on the uplink control channel not overlapping in time with the uplink shared channel during the time period.

11. The method of claim 1, further comprising:
receiving the configuration via radio resource control signaling.

12. A method for wireless communications at a base station, comprising:
determining a capability of a user equipment (UE) to perform at least a first mode of uplink control information transmission and a second mode of uplink control information transmission, the first mode corresponding to transmission of uplink control information on an uplink control channel that overlaps at least in part an uplink shared channel, and the second mode corresponding to transmission of the uplink control information multiplexed on the uplink shared channel;
transmitting, to the UE, a configuration indicating that the UE is to use first mode of uplink control information transmission; and
receiving, based at least in part on the transmitted configuration, the uplink control information on the uplink control channel and an uplink signal on the uplink shared channel.

13. The method of claim 12, further comprising:
receiving, from the UE, an indication of the determined capability.

14. The method of claim 12, wherein the configuration is transmitted based at least in part on the uplink control channel lacking a beam configuration.

15. The method of claim 12, further comprising:
determining that the uplink control channel and the uplink shared channel are configured on a same serving cell, wherein the capability of the UE is determined based at least in part on the uplink control channel and the uplink shared channel being configured on the same serving cell.

16. The method of claim 12, further comprising:
determining that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

17. The method of claim 12, further comprising:
determining that the uplink control channel overlaps in time at least in part with the uplink shared channel during a time period, wherein the uplink control channel and the uplink shared channel are configured on the same serving cell.

18. The method of claim 17, further comprising:
receiving, from the UE, a multiplexed transmission comprising a first type of channel state information reporting based at least in part on an absence of a second type of channel state information reporting.

19. The method of claim 18, wherein the first type of channel state information reporting is periodic and the second type of channel state information is aperiodic or semi-persistent.

20. The method of claim 12, further comprising:
receiving, from the UE, a scheduling request based at least in part on the uplink control channel not overlapping in time with the uplink shared channel during a time period.

21. The method of claim 12, further comprising:
transmitting the configuration via radio resource control signaling.

22. An apparatus for wireless communications at a user equipment (UE), comprising:
a processor,
memory coupled with the processor; and
instructions stored in the memory and executable h processor to cause the apparatus to:
determine a capability of the UE to perform at least a first mode of uplink control information transmission and a second mode of uplink control information transmission, the first mode corresponding to transmission of uplink control information on an uplink control channel that overlaps in time at least in part with an uplink shared channel, and the second mode corresponding to transmission of the uplink control information multiplexed on the uplink shared channel;
receive, from a base station, a configuration indicating that the UE is to use the first mode of uplink control information transmission; and
transmit, based at least in part on the received configuration, the uplink control information on the uplink control channel and an uplink signal on the uplink shared channel.

23. The apparatus of claim 22, wherein the instructions are further executable by the processor to cause the apparatus to:
transmit, to the base station, an indication of the determined capability.

24. The apparatus of claim 22, wherein the configuration is received based at least in part on the uplink control channel lacking a beam configuration.

25. The apparatus of claim 22, wherein the instructions are further executable by the processor to cause the apparatus to:
determine that the uplink control channel and the uplink shared channel are configured on a same serving cell, wherein the capability of the UE is determined based at least in part on the uplink control channel and the uplink shared channel being configured on the same serving cell.

26. The apparatus of claim 22, wherein the instructions are further executable by the processor to cause the apparatus to:
determine that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

27. The apparatus of claim 22, wherein the instructions are further executable by the processor to cause the apparatus to:
determine that the uplink control channel overlaps in time at least in part with the uplink shared channel during a time period, wherein the uplink control channel and the uplink shared channel are configured on the same serving cell.

28. The apparatus of claim 27, wherein the instructions are further executable by the processor to cause the apparatus to:
drop a scheduling request based at least in part on the uplink control channel overlapping with the uplink shared channel during the time period.

29. The apparatus of claim 27, wherein the instructions are further executable by the processor to cause the apparatus to:
determine an absence of a second type of channel state information reporting during the time period; and
multiplex a first type of channel state information reporting based at least in part on the absence of the second type of channel state information reporting.

30. The apparatus of claim 29, wherein the first type of channel state information reporting is periodic and the second type of channel state information is aperiodic or semi-persistent.

31. The apparatus of claim 22, wherein the instructions are further executable by the processor to cause the apparatus to:
determine the uplink control channel does not overlap in time with the uplink shared channel during a time period; and
transmit, to the base station, a scheduling request based at least in part on the uplink control channel not overlapping in time with the uplink shared channel during the time period.

32. The apparatus of claim 22, wherein the instructions are further executable by the processor to cause the apparatus to:
receive the configuration via radio resource control signaling.

33. An apparatus for wireless communications at a base station, comprising:
a processor,
memory coupled with the processor; and
instructions stored in the memory and executable by the processor to cause the apparatus to:
determine a capability of a user equipment (UE) to perform at least a first mode of uplink control information transmission and a second mode of uplink control information transmission, the first mode corresponding to transmission of uplink control information on an uplink control channel that overlaps at least in part an uplink shared channel, and the second mode corresponding to transmission of the uplink control information multiplexed on the uplink shared channel;
transmit, to the UE, a configuration indicating that the UE is to use the first mode of uplink control information transmission; and
receive, based at least in part on the transmitted configuration, the uplink control information on the uplink control channel and an uplink signal on the uplink shared channel.

34. The apparatus of claim 33, wherein the instructions are further executable by the processor to cause the apparatus to:
receive, from the UE, an indication of the determined capability.

35. The apparatus of claim 33, wherein the configuration is transmitted based at least in part on the uplink control channel lacking a beam configuration.

36. The apparatus of claim 33, wherein the instructions are further executable by the processor to cause the apparatus to:
determine that the uplink control channel and the uplink shared channel are configured on a same serving cell, wherein the capability of the UE is determined based at least in part on the uplink control channel and the uplink shared channel being configured on the same serving cell.

37. The apparatus of claim 33, wherein the instructions are further executable by the processor to cause the apparatus to:
determine that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

38. The apparatus of claim 33, wherein the instructions are further executable by the processor to cause the apparatus to:
determine that the uplink control channel overlaps in time at least in part with the uplink shared channel during a time period, wherein the uplink control channel and the uplink shared channel are configured on the same serving cell.

39. The apparatus of claim 38, wherein the instructions are further executable by the processor to cause the apparatus to:
receive, from the UE, a multiplexed transmission comprising a first type of channel state information reporting based at least in part on an absence of a second type of channel state information reporting.

40. The apparatus of claim 39, wherein the first type of channel state information reporting is periodic and the second type of channel state information is aperiodic or semi-persistent.

41. The apparatus of claim 33, wherein the instructions are further executable by the processor to cause the apparatus to:
receive, from the UE, a scheduling request based at least in part on the uplink control channel not overlapping in time with the uplink shared channel during a time period.

42. The apparatus of claim 33, wherein the instructions are further executable by the processor to cause the apparatus to:
transmit the configuration via radio resource control signaling.

43. An apparatus for wireless communications at a user equipment (UE), comprising:
means for determining a capability of the UE to perform at least a first mode of uplink control information transmission and a second mode of uplink control information transmission, the first mode corresponding to transmission of uplink control information on an uplink control channel that overlaps in time at least in part with an uplink shared channel, and the second mode corresponding to transmission of the uplink control information multiplexed on the uplink shared channel;
means for receiving, from a base station, a configuration indicating that the UE is to use the first mode of uplink control information transmission; and
means for transmitting, based at least in part on the received configuration, the uplink control information on the uplink control channel and an uplink signal on the uplink shared channel.

44. The apparatus of claim 43, further comprising:
means for transmitting, to the base station, an indication of the determined capability.

45. The apparatus of claim 43, wherein the configuration is received based at least in part e uplink control channel lacking a beam configuration.

46. The apparatus of claim 43, further comprising:
means for determining that the uplink control channel and the uplink shared channel are configured on a same serving cell, wherein the capability of the UE is determined based at least in part on the uplink control channel and the uplink shared channel being configured on the same serving cell.

47. The apparatus of claim 43, further comprising:
means for determining that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

48. The apparatus of claim 43, further comprising:
means for determining that the uplink control channel overlaps in time at least in part with the uplink shared channel during a time period, wherein the uplink control channel and the uplink shared channel are configured on the same serving cell.

49. The apparatus of claim 48, further comprising:
means for dropping a scheduling request based at least in part on the uplink control channel overlapping with the uplink shared channel during the time period.

50. The apparatus of claim 48, further comprising:
means for determining an absence of a second type of channel state information reporting during the time period; and
means for multiplexing a first type of channel state information reporting based at least in part on the absence of the second type of channel state information reporting.

51. The apparatus of claim 50, wherein the first type of channel state information reporting is periodic and the second type of channel state information is aperiodic or semi-persistent.

52. The apparatus of claim 43, further comprising:
means for determining the uplink control channel does not overlap in time with the uplink shared channel during a time period; and
means for transmitting, to the base station, a scheduling request based at least in part on the uplink control channel not overlapping in time with the uplink shared channel during the time period.

53. The apparatus of claim 43, further comprising:
means for receiving the configuration via radio resource control signaling.

54. An apparatus for wireless communications at a base station, comprising:
means for determining a capability of a user equipment (UE) to perform at least a first mode of uplink control information transmission and a second mode of uplink control information transmission, the first mode corresponding to transmission of uplink control information on an uplink control channel that overlaps at least in part an uplink shared channel, and the second mode corresponding to transmission of the uplink control information multiplexed on the uplink shared channel;
means for transmitting, to the UE, a configuration indicating that the UE is to use the first mode of uplink control information transmission; and
means for receiving, based at least in part on the transmitted configuration, the uplink control information on the uplink control channel and an uplink signal on the uplink shared channel.

55. The apparatus of claim 54, further comprising:
means for receiving, from the UE, an indication of the determined capability.

56. The apparatus of claim 54, wherein the configuration is transmitted based at least in part on the uplink control channel lacking a beam configuration.

57. The apparatus of claim 54, further comprising:
means for determining that the uplink control channel and the uplink shared channel are configured on a same serving cell, wherein the capability of the UE is determined based at least in part on the uplink control channel and the uplink shared channel being configured on the same serving cell.

58. The apparatus of claim 54, further comprising:
means for determining that the uplink control channel is configured on a first serving cell and the uplink shared channel is configured on a second serving cell different than the first serving cell, wherein the capability of the UE is determined based at least in part on the uplink control channel being configured on a different serving cell than the uplink shared channel.

59. The apparatus of claim 54, further comprising:
means for determining that the uplink control channel overlaps in time at least in part with the uplink shared channel during a time period, wherein the uplink control channel and the uplink shared channel are configured on the same serving cell.

60. The apparatus of claim 59, further comprising:
means for receiving, from the UE, a multiplexed transmission comprising a first type of channel state information reporting based at least in part on an absence of a second type of channel state information reporting.

61. The apparatus of claim 60, wherein the first type of channel state information reporting is periodic and the second type of channel state information is aperiodic or semi-persistent.

62. The apparatus of claim 54, further comprising:
means for receiving, from the UE, a scheduling request based at least in part on the uplink control channel not overlapping in time with the uplink shared channel during a time period.

63. The apparatus of claim 54, further comprising:
means for transmitting the configuration via radio resource control signaling.

64. A non-transitory computer-readable medium storing code for wireless communications at a user equipment (UE), the code comprising instructions executable by a processor to:
determine a capability of the UE to perform at least a first mode of uplink control information transmission and a second mode of uplink control information transmission, the first mode corresponding to transmission of uplink control information on an uplink control channel that overlaps in time at least in part with an uplink shared channel, and the second mode corresponding to transmission of the uplink control information multiplexed on the uplink shared channel;
receive, from a base station, a configuration indicating that the UE is to use the first mode of uplink control information transmission; and
transmit, based at least in part on the received configuration, the uplink control information on the uplink control channel and an uplink signal on the uplink shared channel.

65. A non-transitory computer-readable medium storing code for wireless communications at a base station, the code comprising instructions executable by a processor to:
determine a capability of a user equipment (UE) to perform at least a first mode of uplink control information transmission and a second mode of uplink control information transmission, the first mode corresponding to transmission of uplink control information on an uplink control channel that overlaps at least in part an uplink shared channel, and the second mode corresponding to transmission of the uplink control information multiplexed on the uplink shared channel;
transmit, to the UE, a configuration indicating that the UE is to use the first mode of uplink control information transmission; and
receive, based at least in part on the transmitted configuration, the uplink control information on the uplink control channel and an uplink signal on the uplink shared channel.
